(19) United States
(12) Patent Application Publication
(10) Pub. No.: US 2026/0237544 A1
(43) Pub. Date: Aug. 13, 2026

(54) METHOD FOR PRODUCING R-T-Q SYSTEM SINTERED MAGNET

(71) Applicant: PROTERIAL, LTD., Tokyo (JP)

(72) Inventors: Rintaro ISHII, Tokyo (JP); Futoshi KUNIYOSHI, Tokyo (JP)

(21) Appl. No.: 19/154,957

(22) PCT Filed: Feb. 13, 2024
(86) PCT No.: PCT/JP2024/004870

§ 371 Date: Aug. 8, 2025

(30) Foreign Application Priority Data
Feb. 24, 2023 (JP) 2023-026978

(51) Int. Cl. H01F 1/057

(52) U.S. Cl. CPC H01F 1/0577

(57) ABSTRACT

A method for producing an R-T-Q system sintered magnet according to the present disclosure comprises: a pulverization step in which an alloy powder is formed by pulverizing an R-T-Q system magnet alloy; and a step in which an R-T-Q system sintered magnet is formed by sintering a molded body of the alloy powder. The R content is 30 mass % or less, the B content is 0.90 mass % or less, and the total content of B and C is 0.99 mass % or less. The pulverization step comprises a hydrogen pulverization step and a fine pulverization step, and the hydrogen pulverization step comprises: a hydrogen storage step in which hydrogen is stored in the alloy at a temperature of 200° C. or less within a processing chamber; and a dehydrogenation step in which a dehydrogenation treatment is carried out by discharging hydrogen from the processing chamber and heating the alloy to a temperature within the range from 80° C. to 350° C., thereby forming a coarse pulverized powder that has a hydrogen content of 1,000 ppm to 2,000 ppm. In the fine pulverization step, a fine powder having a median diameter d50 of 3.5 μm or less is obtained by pulverizing the coarse pulverized powder.

### TECHNICAL FIELD

The present invention relates to a method for producing a sintered R-T-Q based magnet.

### BACKGROUND ART

Sintered R-T-B based magnets (where R is at least one of rare-earth elements; T is at least one of transition metal elements and contains Fe with no exception; and B is boron) are known as permanent magnets with the highest performance. Therefore, the sintered R-T-B based magnets are used in various types of motors for electric vehicles (EV, HV, PHV, etc.), for industrial equipment, and the like; consumer electronics; and the like. A sintered R-T-B based magnet includes a main phase mainly formed of an R₂T₁₄B compound and a grain boundary phase (hereinafter, may be referred to simply as a “grain boundary”) that is at the grain boundaries of the main phase. The R₂T₁₄B compound is a ferromagnetic phase having high magnetization.

The sintered R-T-B based magnets have a problem in that coercivity H_{cJ} (hereinafter, may referred to simply as “H_{cJ}”) thereof decreases at high temperatures, thus causing an irreversible thermal demagnetization. For this reason, sintered R-T-Q based magnets for use in motors for electric vehicles, in particular, are required to have high H_{cJ} even at high temperatures.

It is known regarding the sintered R-T-B based magnets that in the case where a light rare-earth element (mainly, Nd and/or Pr) contained in R of an R₂T₁₄B compound is partially replaced with a heavy rare-earth element (mainly, Dy and/or Tb), the H_{cJ} is improved. As the amount of replacement with the heavy rare-earth element is increased, the H_{cJ} is improved.

However, in the case where a light rare-earth element in the R₂T₁₄B compound is replaced with a heavy rare-earth element, remanence Bᵣ (hereinafter, may be referred to simply as “Bᵣ”) of a sintered R-T-B based magnet is decreased although the H_{cJ} thereof is improved. The heavy rare-earth elements, especially, Dy and the like, exist in small amounts as resources and are produced in limited areas, and for these and other reasons, involve problems of not being supplied stably and of being significantly fluctuated in costs. Therefore, users recently demand that the H_{cJ} should be improved using minimum possible amounts of the heavy rare-earth elements.

Patent Document No. 1 discloses a sintered R-T-Q based rare-earth magnet having improved coercivity while having a decreased content of Dy. The composition of this sintered magnet contains B in an amount that is limited in a specific range smaller than that of an R-T-Q based alloy generally used conventionally, and contains at least one metal element selected from Al, Ga and Cu. As a result, an R₂T₁₇ phase is generated at the grain boundary. A transition metal-rich phase (R₆T₁₃M) formed from the R₂T₁₇ phase at the grain boundary has a volumetric ratio increased, and this improves the H_{cJ}.

### CITATION LIST

### Patent Literature

Patent Document No. 1: International Publication WO2013/008756

### SUMMARY OF INVENTION

### Technical Problem

In order to realize a sintered R-T-Q based magnet having high Bᵣ and high H_{cJ} while having a decreased content of a heavy rare-metal element, a technology of decreasing the amount of B (concentration of boron) to a relatively low level to control an intergranular grain boundary to be thick is now being studied. However, it has been found out that in order to thicken the intergranular grain boundary, the amount of C needs to be decreased in addition to the amount of B. A reason for this is that C is partially replaced with B in the main phase, and may have substantially the same function as that of B. Hereinafter, B and C may be collectively represented as Q, and a “sintered R-T-B based magnet” may be referred to as a “sintered R-T-Q based magnet”.

In the meantime, it has also been found out that in the case where the particle size of powder particles (powder particle size) is decreased, the amount of carbon incorporated into the magnetic powder during the production process is increased, and the amount of C in the sintered magnet is increased. Therefore, in the case where the powder particle size is decreased, it is required to suppress such an increase in the amount of C during the production process.

A method for producing a sintered R-T-Q based magnet according to the present disclosure allows the increase in the amount of C to be suppressed even in the case where the powder particle size is decreased.

### Solution to Problem

In a non-limiting illustrative embodiment, a method for producing a sintered R-T-Q based magnet according to the present disclosure includes a pulverization step of pulverizing an R-T-Q based magnet alloy (R is at least one of rare-earth elements and contains at least one of Nd and Pr with no exception, Tis at least one selected from the group consisting of elements of Fe, Co, Ni, Al, Mn, Cr and V, and T contains Fe with no exception, and Q is a total of B and C) to form an alloy powder; and a step of sintering a compact of the alloy powder to form a sintered R-T-Q based magnet. A content of R in the sintered R-T-Q based magnet is not higher than 30 mass % of the entirety of the sintered R-T-Q based magnet, a content of B is not higher than 0.90 mass % of the entirety of the sintered R-T-Q based magnet, and a total content of B and C is not higher than 0.99 mass %. The pulverization step includes a hydrogen pulverization step and a fine pulverization step. The hydrogen pulverization step includes a hydrogen occlusion step of causing the R-T-Q based magnet alloy to occlude hydrogen at a temperature that is not higher than 200° C. in a processing chamber, and a dehydrogenation step of discharging hydrogen from the processing chamber and heating the alloy to a range that is not lower than 80° C. and not higher than 350° C. to perform a dehydrogenation process, thus to form a coarse-pulverized powder having a content of hydrogen that is not lower than 1000 ppm and not higher than 2000 ppm. The fine pulverization step includes a step of pulverizing the coarse-pulverized powder to obtain a fine powder having a median diameter d50 that is not longer than 3.5 μm.

### Advantageous Effects of Invention

According to an embodiment of the present disclosure, the increase in the amount of C is allowed to be suppressed even in the case where the powder particle size is decreased. As a result, the amount of B and the amount of C are each controlled to be in a desired range to realize a sintered R-T-Q based magnet having the intergranular grain boundary improved in the quality.

### BRIEF DESCRIPTION OF DRAWINGS

FIG. 1A is a schematic view showing a main phase and a grain boundary phase of a sintered R-T-B based magnet.

FIG. 1B is an enlarged schematic view of the rectangular area enclosed by the dashed line in FIG. 1A.

FIG. 2 is a flowchart showing an overview of a method for producing a sintered R-T-Q based magnet in an embodiment according to the present disclosure.

FIG. 3 is a table showing compositions of sintered R-T-Q based magnets obtained as final products of samples (samples Nos. 1 through 28) in experiment examples according to the present disclosure.

FIG. 4 is a table showing production conditions and magnetic characteristics of the samples (samples Nos. 1 through 28) in the experiment examples according to the present disclosure.

FIG. 5 is a graph showing the baking temperature dependence of the coarse powder hydrogen amount [ppm] of the experiment examples according to the present disclosure and reference examples.

FIG. 6 is a graph showing the relationship between Bᵣ and H_{cJ} in each of groups I through IV in the experiment examples according to the present disclosure.

FIG. 7 is a graph showing the relationship between H_{cJ} and the content of B in each of groups I through IV in the experiment examples according to the present disclosure.

FIG. 8 is a graph showing the relationship between H_{cJ} and the content of (B+C) in each of groups I through IV in the experiment examples according to the present disclosure.

FIG. 9 is a graph showing the relationship between Bᵣ and the content of B in each of groups I through IV in the experiment examples according to the present disclosure.

FIG. 10 is a table showing compositions of sintered R-T-Q based magnets obtained as final products of samples (samples Nos. 29 through 38) in experiment examples according to the present disclosure.

FIG. 11 is a table showing production conditions and magnetic characteristics of the samples (samples Nos. 29 through 38) in the experiment examples according to the present disclosure.

FIG. 12 is a table showing compositions of sintered R-T-Q based magnets obtained as final products of samples (samples Nos. 39 through 49) in experiment examples according to the present disclosure.

FIG. 13 is a table showing production conditions and magnetic characteristics of the samples (samples Nos. 39 through 49) in the experiment examples according to the present disclosure.

FIG. 14 is a graph showing the relationship between Bᵣ and H_{cJ} in each of groups VIII and IX in the experiment examples according to the present disclosure.

FIG. 15 is a graph showing the relationship between H_{cJ} and the content of B in each of groups VIII and IX in the experiment examples according to the present disclosure.

FIG. 16 is a graph showing the relationship between H_{cJ} and the content of (B+C) in each of groups VIII and IX in the experiment examples according to the present disclosure.

### DESCRIPTION OF EMBODIMENTS

The following is conventionally known regarding a sintered R-T-B based magnet: in the case where, for example, (1) the content of R (at least one of rare-earth elements and contains at least one of Nd and Pr with no exception) is not lower than 27 mass % and not higher than 34 mass % of the entirety of the sintered R-T-B based magnet and (2) T is at least one selected from the group consisting of Fe, Co, Al, Mn and Si, and T contains Fe with no exception, and the content of Fe with respect to the entirety of T is not lower than 80 mass %, (3) when the molar ratio of T with respect to B ([T]/[B]) is higher than 14.0 and not higher than 15.0, it is possible to thicken the intergranular grain boundary to improve the H_{cJ} by incorporating an element of Ga or the like.

The molar ratio of T with respect to B ([T]/[B]) is found as follows. An analysis value (mass %) of the concentration of each of elements contained in T (at least one of Fe or Co, Al, Mn and Si, and Fe) is divided by an atomic weight of the respective element, and the resultant values are added together to find a molar number (a). An analysis value of the concentration of B (mass %) is divided by the atomic weight of B to find a molar number (b). The molar ratio of T with respect to B is a ratio of molar number (a) with respect to molar number (b) (i.e., a/b).

A ratio of T with respect to B ([T]/[B]) that is higher than 14.0 indicates that the content ratio of B is lower than the stoichiometric ratio of the R₂T₁₄B compound. In this case, in the sintered R-T-B based magnet, the amount of B used to form the main phase (R₂T₁₄B compound) is smaller than the amount of T used to form the main phase (R₂T₁₄B compound).

Next, a fundamental structure of a sintered R-T-B based magnet will be described.

The sintered R-T-B based magnet has a structure in which powder particles of a raw material alloy are bound together through sintering, and includes a main phase mainly formed of an R₂T₁₄B compound and a grain boundary phase that is at the grain boundaries of the main phase.

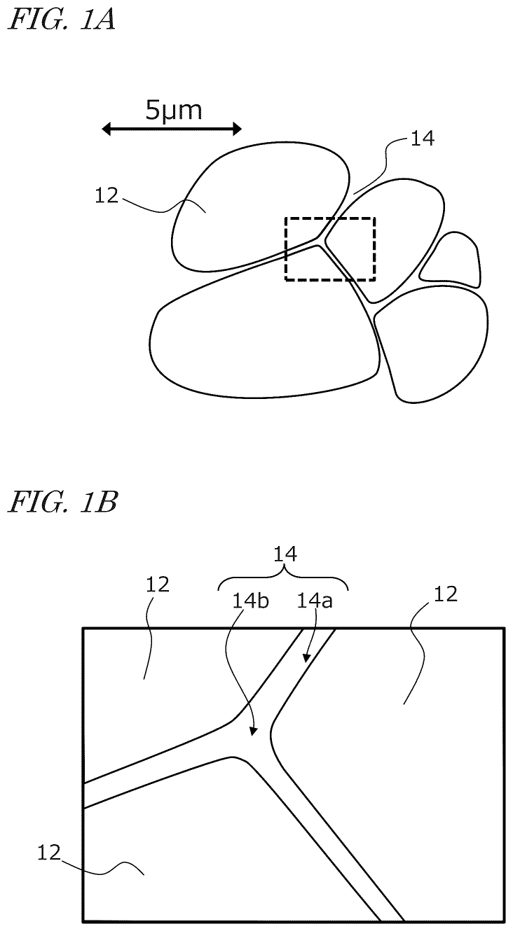

FIG. 1A is a schematic view showing a main phase and a grain boundary phase of a sintered R-T-B based magnet. FIG. 1B is an enlarged schematic view of the rectangular area enclosed by the dashed line in FIG. 1A. In FIG. 1A, an arrow indicating a length of 5 μm is shown as an example of reference length to represent size. As shown in FIG. 1A and FIG. 1B, the sintered R-T-B based magnet includes a main phase 12 mainly formed of an R₂T₁₄B compound and a grain boundary phase 14 at the grain boundaries of the main phase 12. As shown in FIG. 1B, the grain boundary phase 14 includes an intergranular grain boundary phase 14a, along which two R₂T₁₄B compound grains adjoin each other, and a grain boundary triple junction 14b, at which three or more R₂T₁₄B compound grains adjoin one another.

The R₂T₁₄B compound, which forms the main phase 12, is a ferromagnetic phase having high saturation magnetization and an anisotropy field. Therefore, in the sintered R-T-B based magnet, it is possible to improve the Bᵣ by increasing the abundance ratio of the R₂T₁₄B compound, which forms the main phase 12. In order to increase the abundance ratio of the R₂T₁₄B compound, an amount of R, an amount of T and an amount of B in the raw material alloy may be brought closer to the stoichiometric ratio of the R₂T₁₄B compound (i.e., amount of R:amount of T:amount of B=2:14:1). In general, in the case where the amount of B or the amount of R to form the R₂T₁₄B compound is lower than the stoichiometric ratio, a soft magnetic phase such as an Fe phase, an R₂T₁₇ phase or the like is generated in the grain boundary phase 14, and the H_{cJ} drastically decreases. However, in the case where the amount of B is made smaller than the stoichiometric ratio of the R₂T₁₄B compound and at least one metal element M selected from Al, Ga and Cu is incorporated, a transition metal-rich phase (e.g., an R-T-Ga phase), for example, is generated at the grain boundary from the R₂T₁₇ phase, and thus the intergranular grain boundary is thickened. As a result, high H_{cJ} is obtained.

As described above, in order to thicken the intergranular grain boundary of the sintered R-T-B based magnet, the amount of carbon (C) having a function similar to that of boron (B), as well as the amount of B, is important. According to the studies made by the present inventor, it is not preferred that the amount of carbon (C) contained in the sintered R-T-B based magnet is increased during the production of a powder compact that is obtained by pulverizing a magnet alloy used as a raw material.

### EMBODIMENTS

Next, embodiments of the method for producing a sintered R-T-Q based magnet according to the present disclosure will be described.

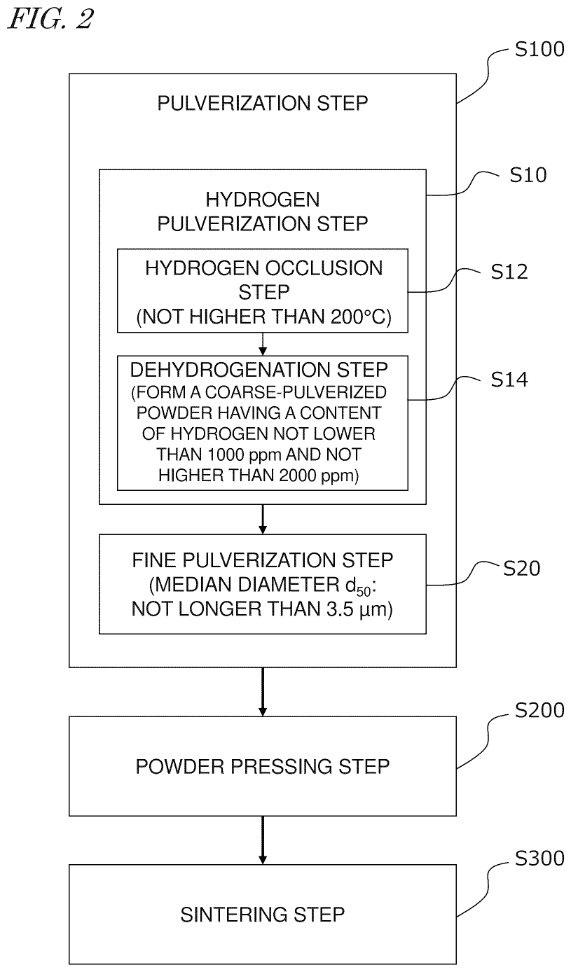

First, with reference to FIG. 2, an overview of the method for producing a sintered R-T-Q based magnet in this embodiment will be described.

As shown in FIG. 2, the method for producing a sintered R-T-Q based magnet in this embodiment includes a pulverization step S100 of pulverizing a sintered R-T-Q based magnet alloy to form an alloy powder, a powder pressing step S200 of forming a compact of the alloy powder, and a sintering step S300 of sintering the compact to form the sintered R-T-Q based magnet. R is at least one of rare-earth elements, and contains at least one of Nd and Pr with no exception. T is at least one selected from the group consisting of elements of Fe, Co, Ni, Al, Mn, Cr and V, and contains Fe with no exception. Q represents a total of B and C. The content of R in the sintered R-T-Q based magnet is not higher than 30 mass % of the entirety of the sintered R-T-Q based magnet. The content of B is not higher than 0.90 mass % of the entirety of the sintered R-T-Q based magnet. The total content of B and C is not higher than 0.99 mass %. Preferably, the content of B is not lower than 0.80 mass % and not higher than 0.90 mass % of the entirety of the sintered R-T-Q based magnet. The total content of B and C is not lower than 0.85 mass % and not higher than 0.99 mass %. The content of R in the sintered R-T-Q based magnet is set to be not higher than 30 mass % of the entirety of the sintered R-T-Q based magnet, and the content of B and the total content of B and C are each set to be in the range according to the present disclosure. With such settings, R₆T₁₃Ga is formed at the grain boundary of the sintered R-T-Q based magnet, and the intergranular grain boundary is thickened. As a result, Bᵣ that is not lower than 1.39 T and high H_{cJ} that exceeds 1640 kA/m are realized. In order to thicken the intergranular grain boundary with more certainty, it is more preferred that the molar ratio of T ([T]/[B]) is higher than 14.0 and not higher than 15.0. The raw material alloy is produced by, for example, a strip cast method or the like. With such a composition, an effect of thickening the intergranular grain boundary described above to realize high He is provided.

The pulverization step S100 includes a hydrogen pulverization step S10 and a fine pulverization step S20.

The hydrogen pulverization step S10 includes a hydrogen occlusion step S12 of causing the above-mentioned alloy to occlude hydrogen at a temperature that is not higher than 200° C. in a processing chamber, and a dehydrogenation step S14 of discharging hydrogen from the processing chamber and heating the alloy to a range that is not lower than 80° C. and not higher than 350° C. to perform a dehydrogenation process, thus to form a coarse-pulverized powder containing hydrogen at a level not lower than 1000 ppm and not higher than 2000 ppm on the mass basis.

In an embodiment of the present disclosure, it is important in the hydrogen pulverization step S10 that the temperature of hydrogen occlusion is set to be not higher than 200° C. to adjust the content of hydrogen in the coarse-pulverized powder to a level not lower than 1000 ppm and not higher than 2000 ppm. As described in examples below, in the case where the content of hydrogen in the coarse-pulverized powder is in the range that is not lower than 1000 ppm and not higher than 2000 ppm, even if the particle size of the powder obtained in the subsequent fine pulverization step 20 (fine-pulverized powder) is decreased, an effect that the increase in the concentration of carbon in the sintered magnet obtained as a final product is suppressed is provided. The content of hydrogen is preferably not lower than 1000 ppm and not higher than 1800 μm.

The fine pulverization step S20 includes a step of pulverizing the coarse-pulverized powder to obtain fine powder having a median diameter of d50 that is not longer than 3.5 μm. The fine pulverization step may include a step of mixing an organic pulverization aid into the coarse-pulverized powder. An example of the organic pulverization aid is zinc stearate. The median diameter d50 of the fine powder is preferably not shorter than 2.0 μm and not longer than 3.5 μm, and more preferably not shorter than 2.0 μm and not longer than 3.0 μm. The median diameter d50 is the volume frequency central value obtained by measurement performed by an airflow-dispersion laser diffraction method. More specifically, the median diameter d50 in an embodiment of the present disclosure refers to d50 measured by a particle size distribution measurement device “HELOS & RODOS” produced by Sympatec GmbH under the conditions of:
dispersive pressure: 4 bar
measurement range: R2, and
calculation mode: HRLD.

In the fine pulverization step S20, the coarse-pulverized powder may be pulverized to have a median diameter d50 that is not longer than 3.5 μm, preferably, not longer than 3.3 μm (e.g., not longer than 3.0 μm), by use of, for example, a jet mill or the like. Note that decreasing the median diameter d50 of an alloy powder to a level shorter than 2.0 μm is very difficult and is not preferred because such decrease significantly declines the production efficiency.

After the powder having a median diameter d50 that is not longer than 3.5 μm is obtained in this manner, in the powder pressing step S200, the alloy powder is, for example, aligned in a magnetic field to form a compact of the alloy powder. In the sintering step S300, the compact of the powder is sintered to form the sintered R-T-Q based magnet. Regarding the sintering temperature, the compact is heated to, for example, a range that is not lower than 900° C. and not higher than 1100° C. There is no specific limitation on the specificities of the powder pressing step 200 or the sintering step S300, and these steps may each be performed by, for example, a known method.

The reason why the increase in the concentration of carbon in the sintered R-T-Q based magnet obtained as a final product is suppressed by adjusting the content of hydrogen in the coarse-pulverized powder to a range that is not lower than 1000 ppm and not higher than 2000 ppm has not been clarified. The researchers including the present inventor consider that the reason for this is that hydrogen in the powder particles heated during the sintering step is bonded with carbon in an organic substance such as a lubricant or the like contained in the powder compact to generate a volatile component and thus becomes easy to volatile.

Conventionally, it is considered as being better that the content of hydrogen in the powder particles is lower. A reason for this is that in the case where the content of hydrogen in the powder particles is high, the following phenomenon is observed: hydrogen released during the sintering step is re-absorbed into the sintered body, and the sintered body expands, and as a result, is broken. However, according to experiments of the present invention, in the case where powder particles having the composition in the above-described range and having a relatively small particle size were used, as long as the content of hydrogen in the coarse-pulverized powder was in the range that is not lower than 1000 ppm and not higher than 2000 ppm, such breakage of the sintered body was not observed. In the case where the content of hydrogen is lower than 1000 ppm, the content of carbon in the sintered magnet obtained as a final product cannot be decreased.

According to an embodiment of the present disclosure, even if the total content of Dy and Tb in the sintered R-T-Q based magnet is not higher than 0.5 mass % (including 0 mass %), it is possible to realize superb magnetic characteristics of Bᵣ≥1.39 T and H_{cJ}≥1640 kA/m.

Various elements may be diffused into the interior of a sintered R-T-Q based magnet produced by the above-described steps from a surface thereof. This improves the magnetic characteristics. In this case, the sintered R-T-Q based magnet before the diffusion may be referred to as a “sintered body material”.

The sintered body material may be formed from one type of raw material alloy (single raw material alloy) or by a method of mixing two or more types of raw material alloys (blend method). The obtained sintered body material may be subjected to a known mechanical process such as cutting, shaving or the like as necessary, and then may be subjected to a first heat treatment and a second heat treatment described below.

In this embodiment, at least one of Nd and Pr may be diffused into the interior of the sintered body material obtained by the above-described method from a surface thereof. As a result of such diffusion, the sintered R-T-Q based magnet includes a portion where at least one of a concentration of NR and a concentration of Pr gradually decreases from the surface of the magnet toward the interior thereof. Similarly, at least one of Tb and Dy may be diffused into the interior of the magnet from a surface thereof. As a result of such diffusion, the sintered R-T-Q based magnet includes a portion where at least one of a concentration of Tb and a concentration of Dy gradually decreases from the surface of the magnet toward the interior thereof.

### Step of Preparing a Diffusion Source

First, a composition of a diffusion source in the step of preparing the diffusion source will be described.

The diffusion source may be formed of a heavy rare-earth element such as Dy, Tb, Gd, Ho or the like. Preferably, the diffusion source contains at least one of Nd and Pr as the rare-earth element with no exception. It is preferred that Pr is contained at a content not lower than 50 mass % of the rare-earth element. A reason for this is that in this manner, higher Has is obtained while the content of a heavy rare-earth element is suppressed. According to the present disclosure, sufficiently high H_{cJ} is obtained without using a large amount of heavy rare-earth element. Therefore, the content of a heavy rare-earth element is preferably not higher than 10 mass %, and more preferably not higher than 5 mass %, with respect to the entirety of the diffusion source. Still more preferably, no heavy rare-earth element is contained (the content of the heavy rare-earth element is substantially 0 mass %). Even in the case where the diffusion source contains a heavy rare-earth element, it is preferred that Pr is contained at a content not lower than 50 mass % of the rare-earth element, and it is more preferred that Pr is the only rare-earth element except for the heavy rare-earth element (unavoidable impurities may be contained).

In the case where at least one of Nd and Pr is contained as a rare-earth element with no exception, the content of the at least one of Nd and Pr is preferably not lower than 35 mass % and lower than 85 mass % with respect to the entirety of the diffusion source. In the case where the content of the rare-earth element is lower than 35 mass %, it is possible that diffusion does not proceed sufficiently in the first heat treatment described below. By contrast, in the case where the content of the rare-earth element is not lower than 85 mass %, the alloy powder in the diffusion source becomes very active during the production process. As a result, the alloy powder may possibly be significantly oxidized or ignited.

The diffusion source may contain, in addition to the above-described elements, Ga, Fe, Cu, Co, Al, Ag, Zn, Si. In, Sn, Zr, Nb, Ti, Ni, Hf, Ta, W, Ge, Mo, V, Y, La, Ce, Sm, Ca, Mg, Mn, Cr, H, F, P, S, CI, O, N, C or the like.

The diffusion source may be prepared by a raw material alloy production method adopted for a general production method represented by a method for producing a sintered Nd—Fe-M based magnet; for example, by a die-cast method, a strip cast method, a single roll rapid quenching method (melt spinning method), an atomization method or the like. The diffusion source may be prepared by pulverizing an alloy obtained as described above by a known pulverization method using a pin mill or the like. In order to improve the ease of pulverization of the alloy obtained as described above, the alloy may be heat-treated at a temperature that is not higher than 700° C. in a hydrogen atmosphere to have hydrogen incorporated thereto before being pulverized.

Step of Diffusing an Element Contained in the Diffusion Source into the Interior of the Sintered Body from a Surface Thereof

The diffusion source is heat-treated at a temperature that is not lower than 700° C. and not higher than 1100° C. in vacuum or an inert gas atmosphere to diffuse an element contained in the diffusion source into the interior of the sintered body from a surface thereof. In the present disclosure, this heat treatment is referred to as a first heat treatment. In the case where the heat-treatment temperature for diffusion is lower than 700° C., the diffusion is insufficient, and it is possible that high H_{cJ} is not obtained. By contrast, in the case where the heat-treatment temperature for diffusion exceeds 1100° C., abnormal grain growth of the main phase occurs, and it is possible that the H_{cJ} is decreased. The heat-treatment temperature for diffusion is preferably not lower than 800° C. and not higher than 1000° C. A reason for this is that at such a temperature, higher H_{cJ} is obtained. Regarding the heat-treatment time period, an appropriate value is set in accordance with the composition or the size of the sintered body or the diffusion source, or the heat-treatment temperature. The heat-treatment time period is preferably not shorter than 5 minute and not longer than 30 hours, more preferably not shorter than 10 minutes and not longer than 25 hours, and still more preferably not shorter than 30 minutes and not longer than 20 hours. It is preferred that the diffusion source is prepared so as to be contained at a content that is not lower than 1 mass % and not higher than 30 mass % with respect to the weight of the sintered body material. In the case where the content of the diffusion source is lower than 1 mass % with respect to the weight of the sintered body material, it is possible that the H_{cJ} is decreased. By contrast, in the case where the content of the diffusion source exceeds 30 mass %, it is possible that the Bᵣ is decreased.

The heat treatment for diffusion may be performed by a known heat-treatment method. For example, a surface of the sintered body material may be covered with a powder layer of the diffusion source to perform the first heat treatment. For example, the first heat treatment may be performed after the surface of the sintered body material is coated with the diffusion source by a sputtering method. For example, a slurry containing the diffusion source dispersed in a dispersion medium may be applied to the surface of the sintered body material, and then the dispersion medium may be evaporated to put the diffusion source and the sintered body material into contact with each other. Examples of the dispersion medium may be alcohol (ethanol, etc.), NMP (N-methylpyrrolidone), aldehyde, and ketone. The sintered body material processed with the first heat treatment may be subjected to a known mechanical process such as cutting, shaving or the like.

The sintered body material processed with the heat treatment for diffusion may be heat-treated at a temperature that is not lower than 450° C. and not higher than 600° C. in vacuum or an inert gas atmosphere. In the present disclosure, this heat treatment is referred to as a second heat treatment. As a result of the second heat treatment, high Bᵣ and high H_{cJ} are obtained. The temperature of the second heat treatment is not lower than 450° C. and not higher than 600° C., so that generation of an R₆T₁₃Ga phase proceeds. The second heat treatment is preferably performed at a temperature that is not lower than 480° C. and not higher than 560° C. With such a temperature, higher Hos is obtained. Regarding the heat-treatment time period, an appropriate value is set in accordance with the composition or the size of the sintered body, or the heat-treatment temperature. The heat-treatment time period is preferably not shorter than 5 minute and not longer than 20 hours, more preferably not shorter than 10 minutes and not longer than 15 hours, and still more preferably not shorter than 30 minutes and not longer than 10 hours.

### EXAMPLES

Hereinafter, the present disclosure will be described in more detail by way of experiment examples (including examples and reference examples). The present disclosure is not limited to any of the examples.

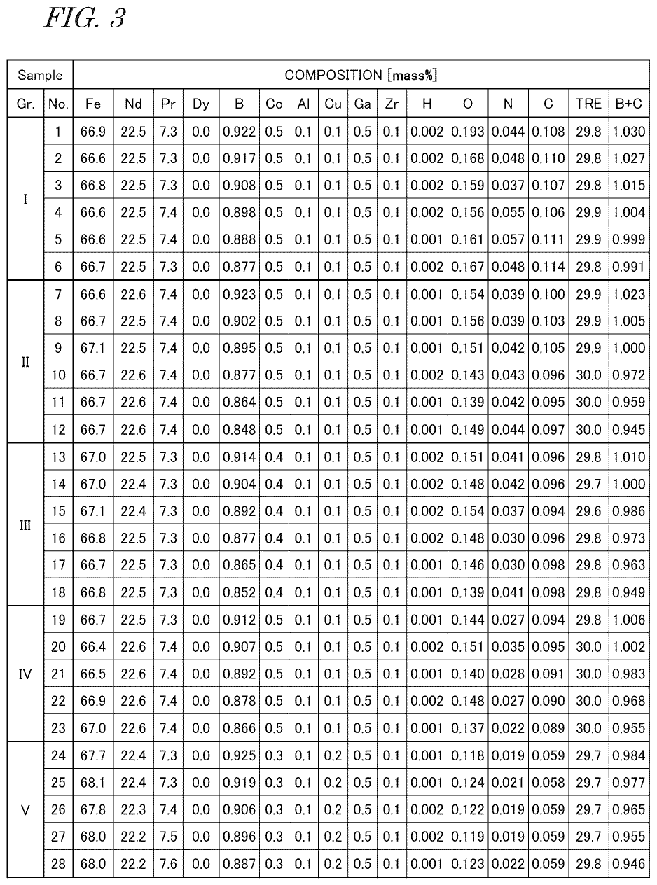

The table in FIG. 3 show compositions of sintered R-T-Q based magnets finally obtained as final products of samples (samples Nos. 1 through 28) in the experiment examples according to the present disclosure. In the table in FIG. 3, the columns labeled as “Sample” show 28 sample Nos. divided into five groups I through V. For each of the samples, the table shows the composition (mass %) of the sintered R-T-Q based magnet. Regarding the composition, the contents were obtained as follows for the samples of the sintered R-T-Q based magnets obtained by performing the production method described below. The contents of Fe, Nd, Pr, Dy, B, Co, Al, Cu, Ga and Zr were analyzed by ICP (Inductively Coupled Plasma) optical emission spectrometry. The amount of H was analyzed by use of a gas analyzer “EMGA-930” produced by Horiba, Ltd., the amounts of O and N were analyzed by use of a gas analyzer “EMGA-920” produced by Horiba, Ltd., and the amount of C was analyzed by use of a gas analyzer “EMIA-920V2/FA” produced by Horiba, Ltd. In the table in FIG. 3, “TRE” represents a total content of the rare-earth elements, and “B+C” represents a total content of B (boron) and carbon (C).

The samples were each obtained by the following steps.

First, a flake-like alloy for a sintered R-T-B based magnet was produced by a strip cast method. The alloy for the sintered R-T-B based magnet was obtained by melting various types of raw material alloys so as to realize the composition shown in the table in FIG. 3 and then cooling and thus solidifying the resultant substance.

The obtained flake-like alloy was put into a processing chamber of a hydrogen pulverization device, and the hydrogen occlusion step was performed in the processing chamber in a pressurized hydrogen atmosphere. The hydrogen occlusion step was performed at a temperature that was not higher than 200° C., specifically, at 80° C. As a result of the hydrogen occlusion step, the alloy occluded hydrogen and was embrittled.

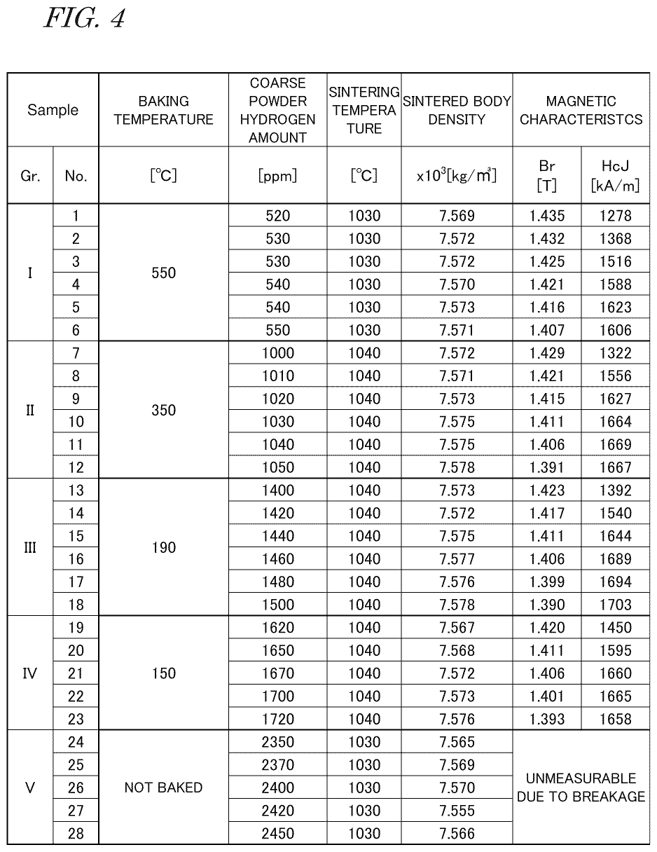

Next, the dehydrogenation process was performed, by which hydrogen was discharged from the processing chamber and the alloy was heated (baked) to a predetermined temperature in vacuum and then cooled. As a result, a coarse-pulverized powder was obtained. As the baking temperature for the dehydrogenation process, different values were set for groups I through V as shown in the table in FIG. 4. Specifically, the baking temperatures for groups I, II, III and IV were respectively 550° C., 350° C., 190° C. and 150° C. For group V, heating (baking) for the dehydrogenation process was not performed.

The amount of hydrogen contained in the coarse-pulverized powder of each sample obtained in this manner (coarse powder hydrogen amount) was measured by the gas analyzer “EMGA-930” produced by Horiba, Ltd. Each of the measured values of the coarse powder hydrogen amount is shown in the table in FIG. 4. In this application, the unit of the coarse powder hydrogen amount is represented by ppm (parts per million) on the mass basis.

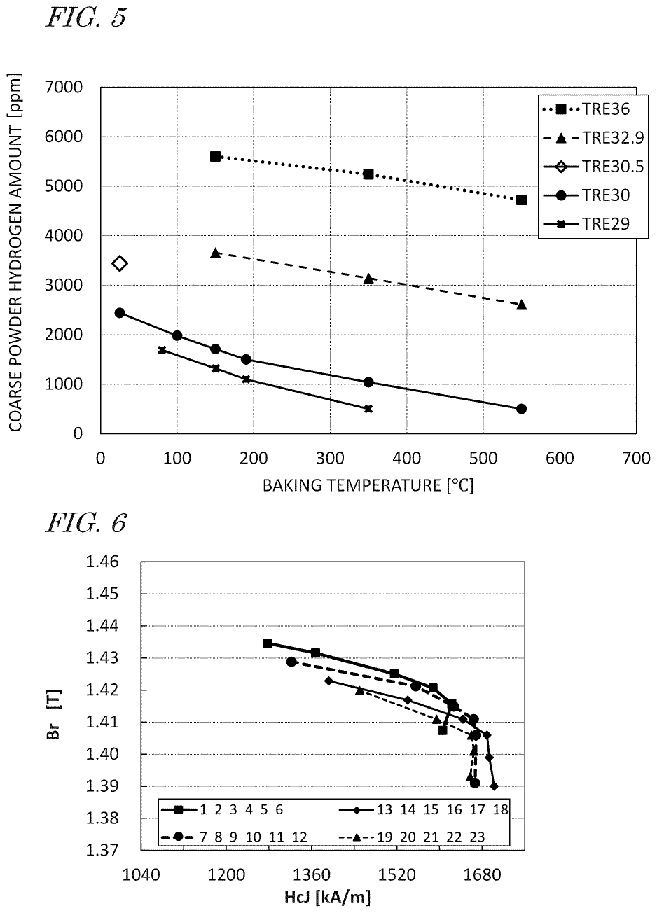

FIG. 5 is a graph showing the baking temperature dependence of the coarse powder hydrogen amount [ppm]. The graph in FIG. 5 also shows the baking temperature dependences of the coarse powder hydrogen amount [ppm] in reference examples having total contents TRE of the rare-earth elements of 36 mass % and 32.9 mass %, respectively with the dotted line and the dashed line.

As understood from FIG. 5, as the baking temperature decreases, the coarse powder hydrogen amount increases. The coarse powder hydrogen amount of an alloy having a total content TRE of the rare-earth elements that is not higher than 30 mass % exhibits a low value that is not realized by an alloy having a total content TRE of the rare-earth elements of higher than 30 mass %. In the experiment examples of the present disclosure, the total content TRE of the rare-earth elements is not higher than 30 mass %. Therefore, the baking temperature is adjusted to be in the range that is not lower than 80° C. and not higher than 350° C., so that the coarse powder hydrogen amount may be controlled to be in the range that is not lower than 1000 ppm and not higher than 2000 ppm.

The coarse-pulverized powder and zinc stearate were mixed together, and the resultant mixture was put into an airflow crusher (jet mill) to obtain a fine-pulverized powder. Specifically, a fine-pulverized powder having a median diameter d50 of 3.5 μm was obtained. Methyl caprylate was added to the fine-pulverized powder, and then the resultant mixture was immersed in normal dodecane to prepare a slurry. The resultant slurry was pressed in a magnetic field (wet-pressed) to obtain a compact. As a pressing apparatus, a so-called orthogonal magnetic field pressing apparatus (transverse magnetic field pressing apparatus) was used, by which the direction of magnetic field application and the pressurizing direction were orthogonal to each other.

The resultant compact was subjected to the sintering step, by which the resultant compact was held at each of sintering temperatures shown in the table in FIG. 4 for about 5 hours in vacuum, to obtain a sintered body. All the sintered bodies had a density that was not lower than 77.5×10³ kg/m³ (=7.5 g/cm³) as shown in the table in FIG. 4.

The sintered body was heat-treated at 800° C. for 2 hours in vacuum, and then processed into a cube having a side of 7.2 mm. The post-processing cube sample was heat-treated at 500° C. for 2 hours, and then six surfaces of the cube sample were shaved into a cube having a side of 7 mm. The remanence Bᵣ and the coercivity H_{cJ} of the resultant cube were measured by a pulse B—H tracer. All the samples in group V were broken, and therefore, the magnetic characteristics thereof were not measured. Various magnetic characteristics (Bᵣ [T], H_{cJ} [kA/m]) obtained by the measurement are shown in the table in FIG. 4.

As shown in the tables in FIG. 3 and FIG. 4, in the case of samples Nos. 10 through 12, 15 through 18, and 21 through 23, which were examples of the present invention, the content of C was suppressed low, the content of B was not higher than 0.90 mass % of the entirety of the sintered R-T-Q based magnet, and the total content of B and C was not higher than 0.99 mass %. These samples Nos. 10 through 12, 15 through 18, and 21 through 23 each exhibited superb magnetic characteristics that the total content of Dy and Tb in the sintered R-T-Q based magnet was not higher than 0.5 mass % (including 0 mass %) and that Bᵣ and H_{cJ} were Bᵣ≥1.39 T and H_{cJ}≥1640 kA/m.

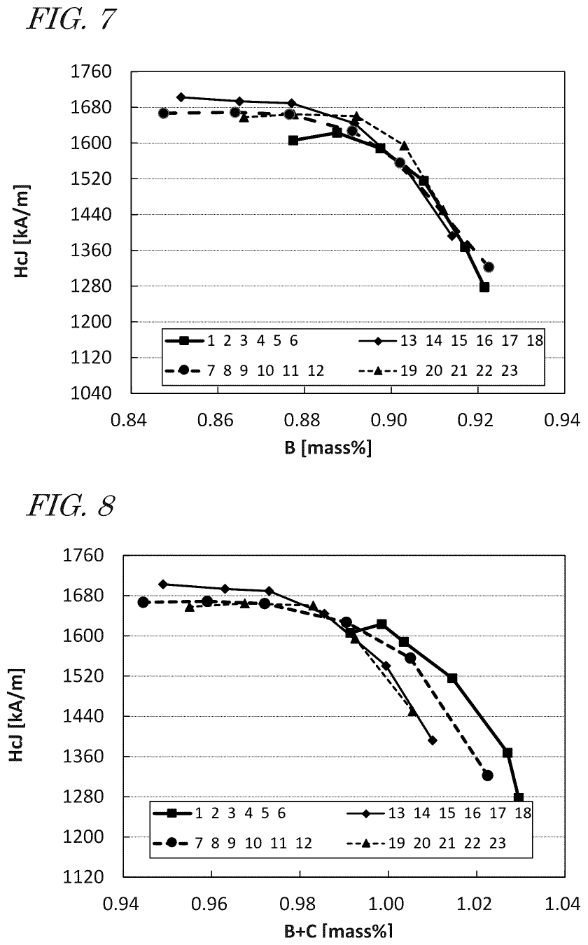

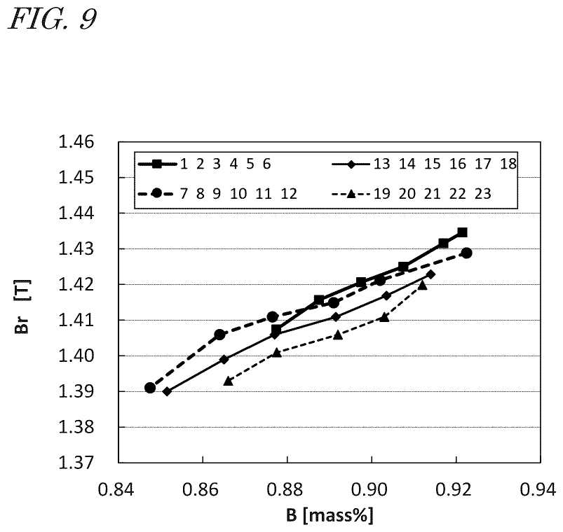

FIG. 6 is a graph showing the relationship between Bᵣ and H_{cJ} in each sample in each group. FIG. 7 is a graph showing the relationship between H_{cJ} and the content of B. FIG. 8 is a graph showing the relationship between H_{cJ} and the content of (B+C). FIG. 9 is a graph showing the relationship between Bᵣ and the content of B. In these graphs, data on group I (samples Nos. 1 through 6) are represented with squares, data on group II (samples Nos. 7 through 12) are represented with circles, data on group III (samples Nos. 13 through 18) are represented with diamond shapes, and data on group IV (samples Nos. 19 through 23) are represented with triangles.

As understood from FIG. 6, in the case of group I with the baking temperature of 500° C., relatively high Bᵣ is obtained, but it is difficult to obtain relatively high H_{cJ}. As understood from FIG. 7 and FIG. 8, in the case of group I, the content of C is higher than that of the other groups, and therefore, the total content of B and C tends to be increased. In addition, as understood from FIG. 9, where the content of B is the same, as the baking temperature is lower, that is, as the coarse powder hydrogen amount is larger, the Bᵣ tends to be decreased. From these, it is preferred that the baking temperature is, for example, not lower than 100° C.

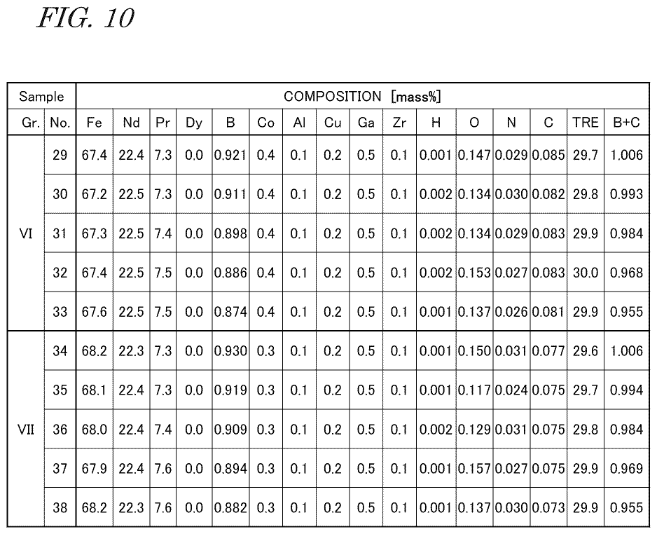

Next, substantially the same experiment examples were performed with different particle sizes of the fine-pulverized powder (fine powder). Main differences from the above-described experiment examples were in the baking temperature and in the fine pulverization step. Referring to the table in FIG. 10, for samples Nos. 29 through 33 in group VI, the baking temperature was set to 150° C., and the fine pulverization step was performed such that the median diameter d50 would be 3.3 μm. By contrast, for samples Nos. 34 through 38 in group VII in the table in FIG. 10, the baking temperature was set to 150° C., and the fine pulverization step was performed such that the median diameter d50 would be 3.6 μm.

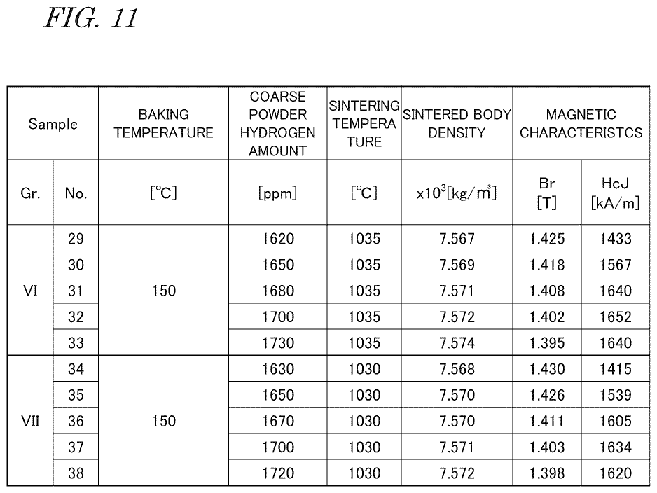

As understood from FIG. 11, in the case where the median diameter d50 was 3.6 μm (group VII), which was longer than 3.5 μm, Bᵣ≥1.39 T was achieved but H_{cJ}≥1640 kA/m was not achieved.

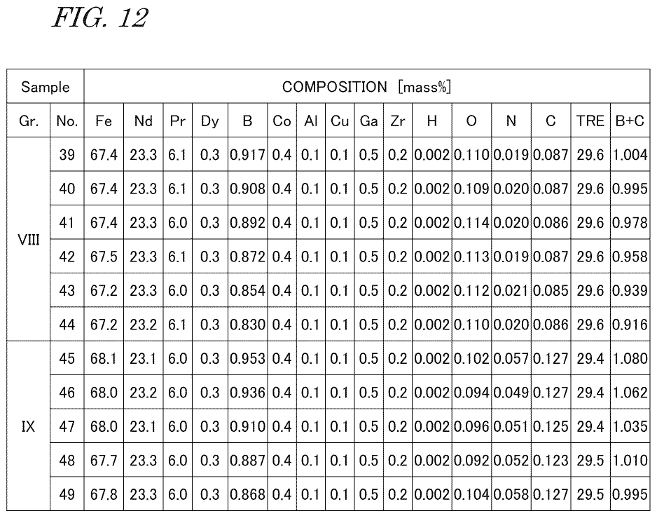

Next, substantially the same experiment examples were performed with smaller particle sizes. Main differences from the above-described experiment examples were in the baking temperature for the dehydrogenation process, in the median diameter d50 of the fine powder formed in the fine pulverization step, and in that the content of Dy in the sintered R-T-Q based magnet was 0.3 mass %. The alloys for the sintered R-T-B based magnets were obtained by melting various types of raw material alloys so as to realize the compositions shown in the table in FIG. 12 and then cooling and thus solidifying the resultant substances. Referring to the table in FIG. 12, for samples Nos. 39 through 44 in group VIII, the baking temperature was set to 100° C., and the fine pulverization step was performed such that the median diameter d50 would be 2.7 μm. By contrast, for samples Nos. 45 through 49 in group IX in the table in FIG. 12, the baking temperature was set to 500° C., and the fine pulverization step was performed such that the median diameter d50 would be 2.7 μm.

Theoretically, as the median diameter d50 of the fine powder is shorter, it is possible to increase the H_{cJ}. However, in reality, as the median diameter d50 is shorter, the surface area per unit volume of each of powder particles forming the fine powder is increased. Therefore, it is difficult to increase the H_{cJ} due to the influence of the surface area of the powder particle. In addition, it is considered that as the surface area per unit volume of each of the powder particles forming the fine powder is increased, the content of C is more easily increased during the production process. Therefore, it is considered that when the median diameter d50 of the fine powder is, for example, not longer than 3.0 μm, it is difficult to adjust the total content of B and C to a level not higher than 0.90 mass %.

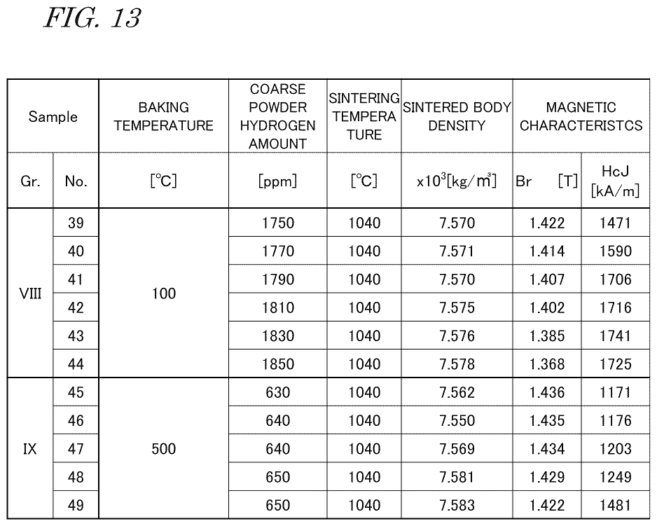

As a result of the experiment examples according to the present disclosure, as understood from FIG. 13, in the case of samples Nos. 41 through 44 with the baking temperature of 100° C. and the median diameter d50 of 2.7 μm (group VIII), high Hos that was not lower than 1700 kA/m was achieved while the Bᵣ was maintained at Bᵣ≥1.30 T. As shown in FIG. 12, the total content of B and C in each of samples Nos. 41 through 44 was not higher than 0.99 mass %, whereas the total content of B and C in each of samples Nos. 39 and 40 exceeded 0.99 mass %.

As understood from FIG. 13, in the case of samples Nos. 45 through 49 with the baking temperature of 500° C. and the median diameter d50 of 2.7 μm (group IX), the coarse powder hydrogen amount was significantly lower than 1000 ppm, and the Hos was not higher than 1500 kA/m. Even though the content of Dy in the sintered R-T-Q based magnet was 0.3 mass %, the H_{cJ} was low. As shown in FIG. 12, the total contents of B and C in all the samples Nos. 45 through 49 in group IX exceeded 0.99 mass %.

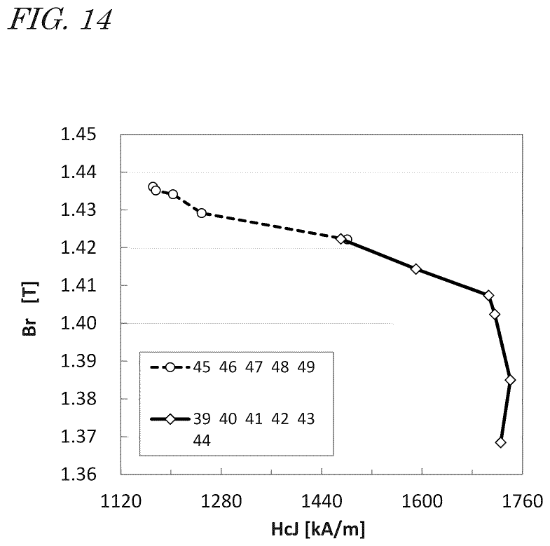

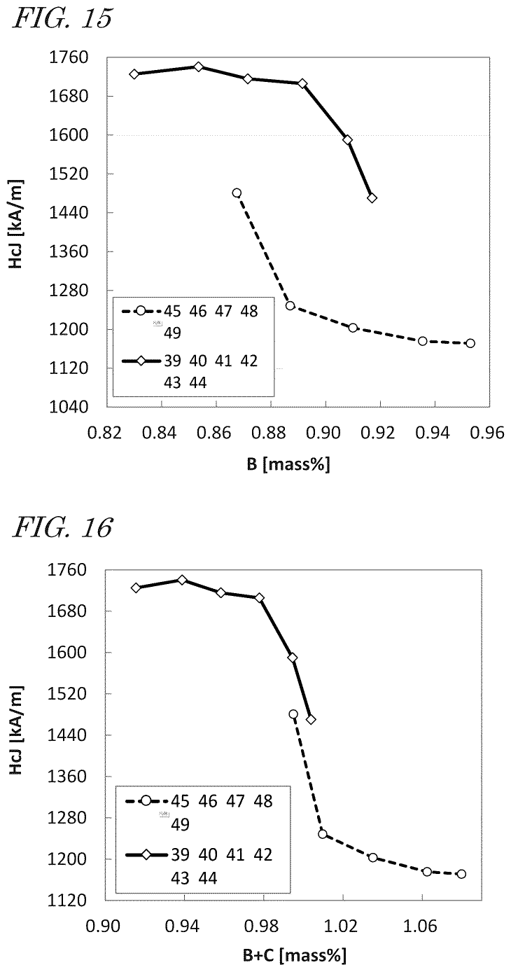

FIG. 14 is a graph showing the relationship between Bᵣ and H_{cJ} in group VIII and group IX. FIG. 15 is a graph showing the relationship between H_{cJ} and the content of B. FIG. 16 is a graph showing the relationship between H_{cJ} and the content of (B+C). In these graphs, data on group VIII (samples Nos. 39 through 44) are represented with white diamond shapes, and data on group IX (samples Nos. 45 through 49) are represented with white circles.

As understood from FIG. 14, in the case of group VIII with the median diameter d50 of as short as 2.7 μm and the baking temperature of 100° C., high H_{cJ} was realized. Specifically, samples Nos. 41 through 44 with the total content of B and C that was not higher than 0.99 mass %, among the samples in group VIII, achieved high H_{cJ} exceeding 1700 kA/m.

As understood from FIG. 15 and FIG. 16, in the case of group VIII (samples Nos. 39 through 44) with the baking temperature of 100° C., the increase in the content of C was suppressed as compared with the case of group IX (samples Nos. 45 through 49) with the baking temperature of 500° C., and a low total content of B and C that was not higher than 0.99 mass % was realized. In general, it is considered that as the median diameter d50 is shorter, the surface area of the fine powder is increased and therefore, the content of C is more easily increased during the production process. Accordingly, the effect of the present invention of suppressing the increase in the content of C is considered to be especially conspicuous in the case where a fine powder having a median diameter d50 that is not longer than 3.0 μm is used to produce a sintered R-T-Q based magnet.

From the experiment examples of the present disclosure, it is understood that even for producing a fine powder having a median diameter d50 that is not longer than 3.0 μm (e.g., 2.6 to 2.8 μm), the baking temperature in the hydrogen pulverization step is adjusted to form a coarse-pulverized powder having a content of hydrogen not lower than 1000 ppm and not higher than 2000 ppm, so that the total content of B and C may easily be put into a desired range, and therefore, higher H_{cJ} is achieved.

As described above, the present disclosure includes a method for producing a sintered R-T-Q based magnet described in the following items.

### [Item 1]

A method for producing a sintered R-T-Q based magnet, comprising:
a pulverization step of pulverizing an R-T-Q based magnet alloy (R is at least one of rare-earth elements and contains at least one of Nd and Pr with no exception, T is Fe or Fe and Co, and at least one selected from the group consisting of elements of Fe, Co, Ni, Al, Mn, Cr and V and contains Fe with no exception, and Q is a total of B and C) to form an alloy powder;
a powder pressing step of producing a compact of the alloy powder; and
a sintering step of sintering the compact to form a sintered R-T-Q based magnet,
wherein a content of R in the sintered R-T-Q based magnet is not higher than 30 mass % of the entirety of the sintered R-T-Q based magnet, a content of B is not higher than 0.90 mass % of the entirety of the sintered R-T-Q based magnet, and a total content of B and C is not higher than 0.99 mass %,
wherein the pulverization step includes a hydrogen pulverization step and a fine pulverization step,
wherein the hydrogen pulverization step includes:
   a hydrogen occlusion step of causing the alloy to occlude hydrogen at a temperature that is not higher than 200° C. in a processing chamber, and
   a dehydrogenation step of discharging hydrogen from the processing chamber and heating the alloy to a range that is not lower than 80° C. and not higher than 350° C. to perform a dehydrogenation process, thus to form a coarse-pulverized powder having a content of hydrogen that is not lower than 1000 ppm and not higher than 2000 ppm, and
wherein the fine pulverization step includes a step of pulverizing the coarse-pulverized powder to obtain a fine powder having a median diameter d50 that is not longer than 3.5 μm.

### [Item 2]

The method for producing a sintered R-T-Q based magnet of item 1, wherein the content of hydrogen is not lower than 1000 ppm and not higher than 1800 ppm.

### [Item 3]

The method for producing a sintered R-T-Q based magnet of item 1 or 2,
wherein a total content of Dy and Tb in the sintered R-T-Q based magnet is not higher than 0.5 mass % (including 0 mass %),

$$wherein {B}_{r} \geq 1.39 T , and$$

$$where {H}_{cJ} \geq 1640 kA / m .$$

### [Item 4]

The method for producing a sintered R-T-Q based magnet of any one of items 1 through 3, wherein the fine pulverization step includes a step of pulverizing the coarse-pulverized powder to obtain a fine powder having a median diameter d50 that is not longer than 3.3 μm.

### [Item 5]

The method for producing a sintered R-T-Q based magnet of any one of items 1 through 4, wherein the fine pulverization step includes a step of mixing an organic pulverization aid into the coarse-pulverized powder.

### [Item 6]

The method for producing a sintered R-T-Q based magnet of any one of items 1 through 5, wherein the powder pressing step is performed by a wet pressing method.

### [Item 7]

The method for producing a sintered R-T-Q based magnet of any one of items 1 through 6, wherein the fine pulverization step is performed by use of a jet mill.

### [Item 8]

The method for producing a sintered R-T-Q based magnet of any one of items 1 through 7,
wherein the sintered R-T-Q based magnet contains at least one of Dy and Tb, and a total content of Dy and Tb is higher than 0 mass % and not higher than 0.5 mass %,

$$wherein {B}_{r} \geq 1.3 T , and$$

$$where {H}_{cJ} \geq 1700 kA / m .$$

### [Item 9]

The method for producing a sintered R-T-Q based magnet of any one of items 1 through 8, wherein the fine pulverization step includes a step of pulverizing the coarse-pulverized powder to obtain a fine powder having a median diameter d50 that is not longer than 3.0 μm.

### REFERENCE SIGNS LIST

12 main phase
14 grain boundary phase
14a intergranular grain boundary phase
14b grain boundary triple junction

1. A method for producing a sintered R-T-Q based magnet, comprising:
a pulverization step of pulverizing an R-T-Q based magnet alloy (R is at least one of rare-earth elements and contains at least one of Nd and Pr with no exception, T is at least one selected from the group consisting of elements of Fe, Co, Ni, Al, Mn, Cr and V, and T contains Fe with no exception, and Q is a total of B and C) to form an alloy powder;
a powder pressing step of producing a compact of the alloy powder; and
a sintering step of sintering the compact to form a sintered R-T-Q based magnet,
wherein a content of R in the sintered R-T-Q based magnet is not higher than 30 mass % of the entirety of the sintered R-T-Q based magnet, a content of B is not higher than 0.90 mass % of the entirety of the sintered R-T-Q based magnet, and a total content of B and C is not higher than 0.99 mass %,
wherein the pulverization step includes a hydrogen pulverization step and a fine pulverization step,
wherein the hydrogen pulverization step includes:
a hydrogen occlusion step of causing the R-T-Q based magnet alloy to occlude hydrogen at a temperature that is not higher than 200° C. in a processing chamber, and
a dehydrogenation step of discharging hydrogen from the processing chamber and heating the alloy to a range that is not lower than 80° C. and not higher than 350° C. to perform a dehydrogenation process, thus to form a coarse-pulverized powder having a content of hydrogen that is not lower than 1000 ppm and not higher than 2000 ppm, and
wherein the fine pulverization step includes a step of pulverizing the coarse-pulverized powder to obtain a fine powder having a median diameter d50 that is not longer than 3.5 μm.

2. The method for producing a sintered R-T-Q based magnet of claim 1, wherein the content of hydrogen is not lower than 1000 ppm and not higher than 1800 ppm.

3. The method for producing a sintered R-T-Q based magnet of claim 1,
wherein a total content of Dy and Tb in the sintered R-T-Q based magnet is not higher than 0.5 mass % (including 0 mass %),
$$wherein {B}_{r} \geq 1.39 T , and$$
$$where {H}_{cJ} \geq 1640 kA / m .$$

4. The method for producing a sintered R-T-Q based magnet of claim 1, wherein the fine pulverization step includes a step of pulverizing the coarse-pulverized powder to obtain a fine powder having a median diameter d50 that is not longer than 3.3 μm.

5. The method for producing a sintered R-T-Q based magnet of claim 1, wherein the fine pulverization step includes a step of mixing an organic pulverization aid into the coarse-pulverized powder.

6. The method for producing a sintered R-T-Q based magnet of claim 1, wherein the powder pressing step is performed by a wet pressing method.

7. The method for producing a sintered R-T-Q based magnet of claim 1, wherein the fine pulverization step is performed by use of a jet mill.
